(19) United States
(12) Patent Application Publication
(10) Pub. No.: US 2012/0137442 A1
(43) Pub. Date: Jun. 7, 2012

(54) CEILING MOUNTED OVER-BED TRAPEZE APPARATUS

(76) Inventors: Christopher Lagana, Dublin, OH (US); Tabitha Campbell, Hilliard, OH (US)

(21) Appl. No.: 13/309,416

(22) Filed: Dec. 1, 2011

Related U.S. Application Data
(60) Provisional application No. 61/419,048, filed on Dec. 2, 2010.
(60) Provisional application No. 61/553,145, filed on Oct. 28, 2011.

(51) Int. Cl. A61G 7/053

(52) U.S. Cl. 5/662

(57) ABSTRACT

Methods, systems, and apparatuses are disclosed for a ceiling mount over-bed trapeze apparatus.

### CROSS-REFERENCE TO RELATED APPLICATION

The application claims priority from U.S. Provisional Patent Application No. 61/419,048, filed on Dec. 2, 2010, and U.S. Provisional Patent Application No. 61/553,145, filed on Oct. 28, 2011, each of which is incorporated by reference herein in its entirety.

### BACKGROUND

Hospital inpatients and other persons of limited ambulation typically spend extended periods of time in bed. During this time, they often are not easily able to reposition themselves while in bed due to injury, general physical weakness, and/or obesity. This is problematic for a number of reasons. First, the inability to shift one's body while in bed can leave a patient uncomfortable and unable to perform basic activities such as sitting upright to eat, reaching personal items, and getting in and out of bed. Second, it raises clinical concerns related to the maintenance of healthy circulation and the prevention of bed sores. Clinically, it is very important to keep the patient as mobile as possible. If the patient is not able to get up and move around, he or she faces an increased risk of developing a deep vein thrombosis (DVT). Further, the patient needs to have the ability to move as freely as possible while awake to avoid excessive pressure on particular areas of the body and so, prevent development of bed sores.

Typically, in a hospital setting, a patient is provided with a triangular trapeze bar that is suspended above the bed, which the patient can use to lift her body and reposition. This trapeze bar is hung from a support rail that is attached to posts that, in turn, attach to the hospital bed frame. Typically, the posts sit in special sockets in the bed frame. The support rail(s) and posts that suspend it collectively are generally known as a traction system.

Traction systems that support trapeze attachments pose several concerns ranging from safety and overall quality of care, to commercial practicality. Support rails may not readily fit in elevators or pass through door openings. Therefore, when a patient presents in an emergency situation, treatment may be delayed by the need to remove the traction system frame so that the patient can be transported to a more appropriate care setting. In an emergency situation, the time it takes to disassemble the traction system before moving the patient can have a serious negative impact on the well-being or survival of the patient. Furthermore, the cumbersome and sometimes jagged parts can cause injury to healthcare workers and other care providers. Another risk posed by these traction systems is that they obstruct care providers' range of movement at the bedside, interfering with the provision of medical and quality of life care. The posts affixed to the bed also can become entangled with wall-mounted equipment, cords, tubing, and lighting commonly found in modern hospital rooms.

Manufacturers and health care providers struggle with the complex and obstructive design of the systems, as well as the lack of ability to bear the weight of the patient. After 60 years of use and little change in design, these systems continue to be a source of dissatisfaction among hospital staff. There exists a long-felt need for a simple, robust frame system that can support a trapeze without physically interfering with other equipment and care providers' ability to access and transport the patient.

### SUMMARY

In one embodiment, an apparatus is provided, the apparatus comprising: a frame member attached to a joist of a ceiling; two or more rails spaced apart in a substantially parallel arrangement and secured to and below the frame member; and a trapeze system anchored to the two or more rails and configured to be positioned above a bed.

In another embodiment, an apparatus is provided, the apparatus comprising: a frame member attached to a joist of a ceiling; two or more rails spaced apart in substantially parallel arrangement and secured to the frame member; and a trapeze system anchored to the two or more rails and configured to be positioned above a bed; and at least two rail connecting members, each having an upper end secured to the lower end of a ceiling connecting member and configured for receiving the two or more rails. The frame member comprises at least two ceiling connecting members, each having an upper end secured to the joist of a ceiling, and a lower end, which extends to, slightly below, or slightly above the ceiling surface. The ceiling connection members are arranged in a linear, square, or rectangular configuration.

In another embodiment, an apparatus is provided, the apparatus comprising: a frame member attached to a joist of a ceiling; two or more rails spaced apart in substantially parallel arrangement and secured to and under the frame member; an actuation system comprising at least one of a linear actuator and a pivoting linkage, operatively connected to the frame member and two or more rails, wherein the actuation system is configured to cause at least one of the raising and lowering of the two or more rails; and a trapeze system anchored to the two or more rails and configured to be positioned above a bed.

In another embodiment, a method for installing a trapeze system for use by a subject in a bed is provided, the method comprising: securing a frame member to a ceiling joist above the bed; connecting to the frame member two or more rails spaced apart in parallel arrangement and secured to and under the frame member; and anchoring a trapeze system to the two or more rails, wherein the trapeze system is configured to be positioned above the bed.

In another embodiment, an apparatus is provided, the apparatus comprising: a first grasping member comprising a substantially horizontal handle having a horizontal cross-section that is at least one of substantially circular and substantially oval; a second grasping member connected to the first grasping member in at least one point and extending at least partially across the first grasping member, the second grasping member comprising a substantially horizontal handle having a horizontal cross-section that is substantially linear; a supporting structure operatively connecting first and second grasping members to at least one rail; and an adjustable connection device configured to operatively connect the supporting structure to at least one rail, wherein the adjustable connection device causes the first and second grasping member to remain in at least two height positions.

### BRIEF DESCRIPTION OF THE DRAWINGS

The accompanying figures, which are incorporated in and constitute a part of the specification, illustrate various example systems, methods, and results, and are used merely to illustrate various example embodiments.

FIG. 1 illustrates an example arrangement of a ceiling mounted over-bed trapeze apparatus.

FIG. 2 illustrates another example arrangement of a ceiling mounted over-bed trapeze apparatus.

FIG. 3a illustrates an example arrangement of a retractable ceiling mounted over-bed trapeze apparatus.

FIG. 3b illustrates an example actuation system for use with the retractable ceiling mounted over-bed trapeze apparatus illustrated in FIG. 3a.

FIG. 4a illustrates another example arrangement of a retractable ceiling mounted over-bed trapeze apparatus.

FIG. 4b illustrates a side view of an example actuation system for use with the retractable ceiling mounted over bed trapeze apparatus illustrated in FIG. 4a.

FIG. 4c illustrates a front view of the example actuation system illustrated in FIG. 4b.

FIG. 4d illustrates an alternative side view of the example actuation system illustrated in FIG. 4b.

FIG. 4e illustrates a front view of the example actuation system illustrated in FIG. 4b.

FIG. 5a illustrates another example arrangement of a retractable ceiling mounted over-bed trapeze apparatus.

FIG. 5b illustrates a side view of an example actuation system for use with the retractable ceiling mounted over-bed trapeze apparatus illustrated in FIG. 5a.

FIG. 5c illustrates a front view of the example actuation system illustrated in FIG. 5b.

FIG. 5d illustrates an alternative side view of the example actuation system illustrated in FIG. 5b.

FIG. 6 illustrates an alternative arrangement of a universal trapeze handle.

### DETAILED DESCRIPTION

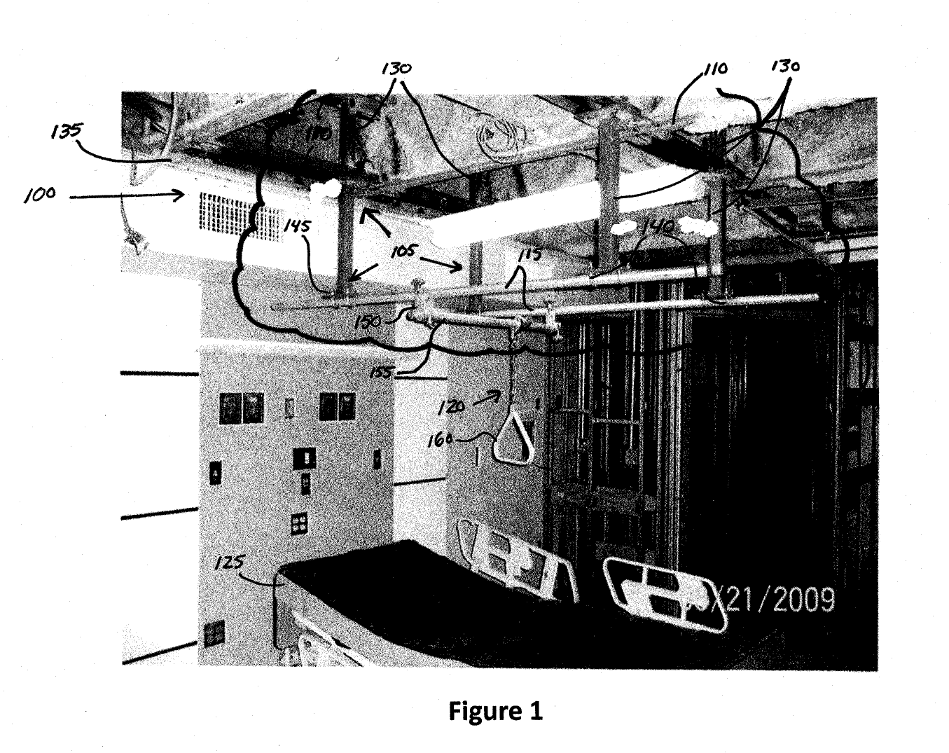

FIG. 1 illustrates one embodiment of an example arrangement of a ceiling mounted over-bed trapeze apparatus 100. Apparatus 100 includes a frame member 105, which is attached to the joist 110 of a ceiling. Two or more rails 115 are secured to and below frame member 105. A trapeze system 120 is anchored to rails 115. Apparatus 100 is configured to be positioned above a bed, and in one particular embodiment, a hospital bed 125.

Frame member 105 may additionally comprise at least two ceiling connecting members 130, each having an upper end secured to joist 110, and a lower end extending to, slightly below, or slightly about the ceiling surface 135. In FIG. 1, much of ceiling surface 135 has been removed to fully illustrate the various components of frame member 105. Ceiling connecting member 130 may be substantially vertical or angled. In one embodiment, ceiling connecting member 130 is configured to attach to one or both of the top flange and bottom flange of joist 110. In another embodiment (not shown), horizontal hangers are positioned between and attached to joist 110. In this embodiment, ceiling connection member 130 may attach to one or more hanger, which is attached to joist 110. In one embodiment, the at least two ceiling connecting members 130 are oriented in a substantially linear, square, or rectangular configuration.

Frame member 105 may further comprise at least two rail connecting members 140, each having an upper end secured to the lower end of a ceiling connecting member 130, and a lower end configured to receive two or more rails 115. Rail connecting members 140 may comprise either structural members or fasteners configured to connect rail 115 to frame member 105. In one embodiment, rail connecting members 140 comprise U-bolts. In another embodiment, the lower end of ceiling connecting member 130 comprises a mounting plate configured to receive and secure the two or more rails 115 directly, without using rail connecting members 140.

Frame member 105 may additionally comprise a mounting plate 145 positioned between each ceiling connecting member 130 and each rail connecting member 140. In this embodiment, mounting plate 145 connects the upper end of each rail connecting member 140 to the lower end of each ceiling connecting member 130. Mounting plate 145 may be configured to facilitate removal of rail connecting member 140 and/or rails 115. In one embodiment, mounting plate 145 is configured to prohibit rotation of at least one of rails 115. In another embodiment, mounting plate 145 is integrated into ceiling connecting member 130 and adapted to receive a U-bolt.

Each of the connections of apparatus 100 components may be attached to joist 110 and one another using at least one or more fasteners such as bolts, U-bolts, screws, clamps, nails, ties, rivets, pins, and quick-disconnect fasteners. Additionally, each of the connections of apparatus 100 components may be attached to one another using rope, chain, glue, epoxy, threaded sections, set screws, friction fitment, and welds.

Two or more rails 115 may comprise elongated members configured to extend from one ceiling connecting member 130 to another. In one embodiment, rails 115 are spaced apart in a substantially parallel arrangement. In another embodiment, rails 115 are oriented in another arrangement, such as perpendicular, square, rectangular, or circular. In one embodiment, apparatus 100 is configured to be positioned over a bed 125. In one embodiment, rails 115 are configured to permit the desired positioning of trapeze system 120.

Trapeze system 120 may further include a bracket 150. Bracket 150 may comprise a top opening configured to receive one of rails 115, and a bottom opening configured to receive a support bar 155. In one embodiment, bracket 150 comprises a lock device configured to eliminate unwanted movement of bracket 150 relative to rails 115 and/or support bar 155. Support bar 155 may be oriented approximately perpendicular to two or more rails 115, and may be configured to span the space between two or more rails 115. In the embodiment wherein support bar 155 spans two or more rails 115, each rail may include a bracket 150, thus connecting each of two or more rails 115 to support bar 155. In another embodiment, a plurality of support bars 155 are utilized in apparatus 100. In one embodiment, trapeze system 120 further includes a trapeze handle 160 connected to support bar 155. In another embodiment, bracket 150 is configured to selectively move longitudinally along rail 115, so as to permit positioning of support bar 155 relative to frame member 105 of apparatus 100. In another embodiment, trapeze handle 160 is configured to selectively move longitudinally along support bar 155, so as to permit positioning of trapeze handle relative to frame member 105.

Each of the ceiling mounted over-bed trapeze apparatus members may be constructed of a variety of materials, including without limitation: a metal, a polymer, an alloy, compound materials, and wood. In one embodiment, one or more of the ceiling mounted over-bed trapeze apparatus members may comprise materials having hollow interiors configured to at least one of reduce the weight of the material and permit control and power wires to be run therein. In another embodiment, one or more of the ceiling mounted over-bed trapeze apparatus members may be constructed of one or more materials that is easily cleaned and disinfected, such as stainless steel, as would be preferable in a healthcare setting.

In one embodiment, the ceiling mounted over-bed trapeze apparatus is configured to offer greater weight-bearing capacity and, thus, reducing the risk of collapse of the apparatus while the patient uses the apparatus to reposition herself, or while care providers use the apparatus to reposition a patient. In another embodiment, the ceiling mounted over-bed trapeze apparatus is oriented so as to be above the workspace of a care provider attending to a patient in a bed, so as to reduce interference with the care provider's range of motion and access to equipment at the bedside. In another embodiment, the ceiling mounted over-bed trapeze apparatus is configured to be used with any hospital bed or consumer bed design, with minimal or no adaptation required. In another embodiment, ceiling mounted over-bed trapeze apparatus 100 is configured such that simply disconnecting each rail connecting member 140 and/or mounting plate 145 from each ceiling connecting member 130 removes most or all of apparatus 100 that is extending below ceiling surface 135, thereby permitting repurposing or renovation of the room in which apparatus 100 is installed.

In one embodiment, the ceiling mounted over-bed trapeze apparatus is modular and configured to accept parts from existing bed-mounted traction systems. In other words, the ceiling mounted over-bed trapeze apparatus may reduce or eliminate the need to dispose of existing bed-mounted traction system components, representing a significant environmental advantage. In another embodiment, the apparatus is configured to support equipment, including without limitation, televisions, telephones, computers, lights, physiological monitors, observation equipment, IV hangers, a call unit/pillow speaker, and a motorized lifter for repositioning a patient.

In one embodiment, a method for installing a trapeze system for use by a patient in a bed is provided. The method comprises a first step of securing a frame member to a ceiling joist above the bed. The frame member may include a ceiling connecting member attached directly to the joist, attached to a hanger that is, in turn, attached to the joist, or a combination of both. The method comprises a second step of connecting two or more rails to the frame member. The rails may be spaced apart in a parallel arrangement, and secured to and under the frame member. The rails may be attached to the ceiling connecting member of the frame member, and may be attached using at least one mounting plate. The method comprises a third step of anchoring a trapeze system to the two or more rails, wherein the trapeze system is configured to be positioned above a bed. The trapeze system may utilize at least one bracket and/or at least one support bar. Further, the trapeze system may include at least one trapeze handle for gripping by a patient. Attachment of each of the components described in this method may be effected utilizing any of the fasteners herein disclosed.

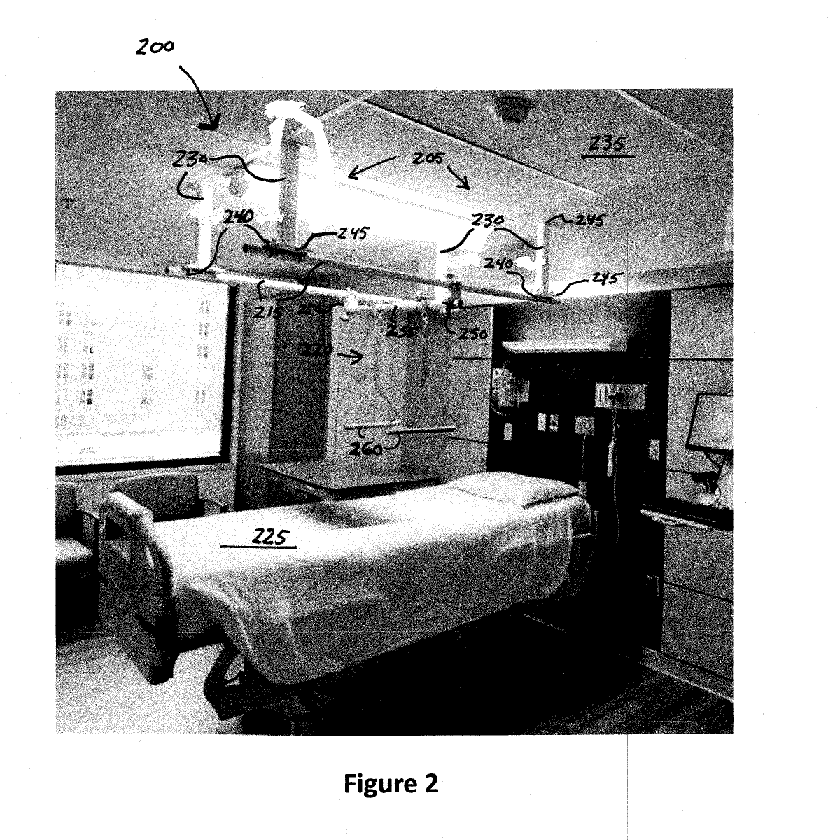

FIG. 2 illustrates an embodiment of an example arrangement of a ceiling mounted over-bed trapeze apparatus 200. Apparatus 200 includes a frame member 205, which is attached to the joist of a ceiling (not shown). Two or more rails 215 are secured to and below frame member 205. A trapeze system 220 is anchored to rails 215. Apparatus 200 is configured to be positioned above a bed, e.g., hospital bed 225. Apparatus 200 further comprises ceiling connecting members 230 extending from rails 215 to ceiling surface 235. Ceiling connecting members 230 are connected to rails 215 via rail connecting members 240. Further, mounting plates 245 are positioned below ceiling connecting members 230 and above rail connecting members 240, and act as an interface between frame member 205 and rails 215. Trapeze system 220 further comprises brackets 250 for connecting support bar 255 to rails 215. Trapeze handles 260 are attached to support bar 255, and may be utilized by a patient in bed 225.

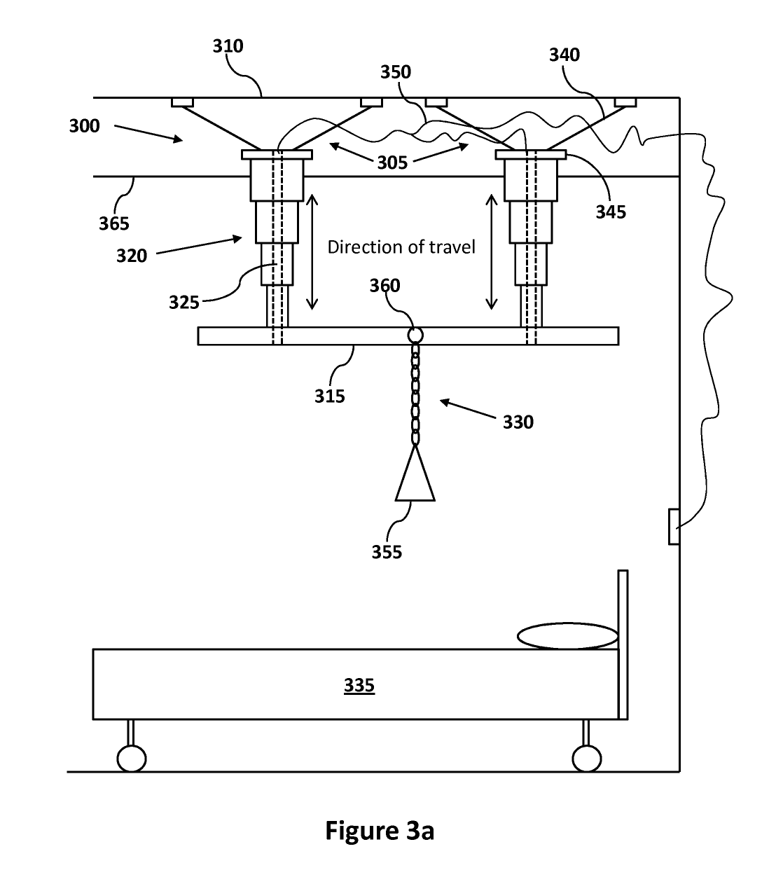

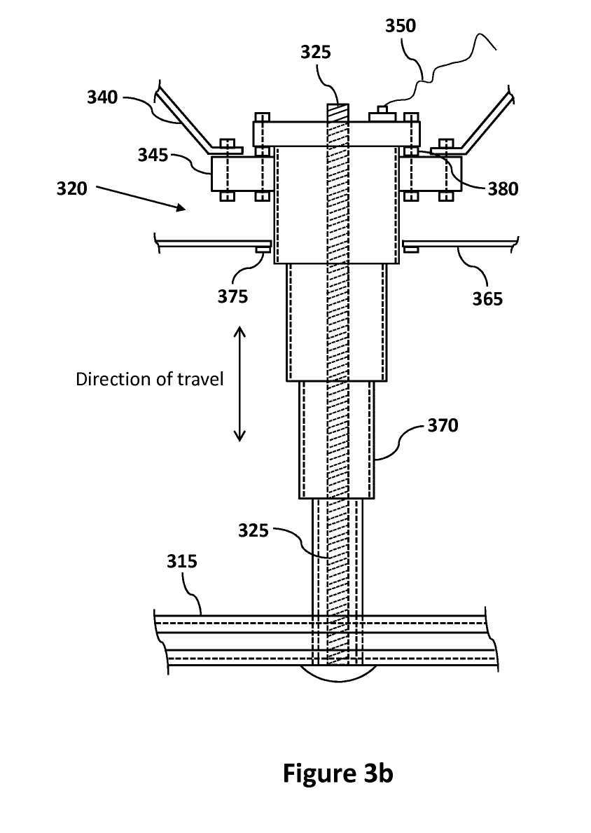

FIG. 3a illustrates an example arrangement of a retractable ceiling mounted over-bed trapeze apparatus 300. Apparatus 300 comprises a frame member 305 connected to a joist of a ceiling 310. Two or more rails 315 are spaced apart in substantially parallel arrangement, and secured to, frame member 305 via an actuation system 320. Actuation system 320 comprises a linear actuator 325. A trapeze system 330 is anchored to two or more rails 315 and configured to be positioned above a bed, e.g., hospital bed 335.

Apparatus 300 is secured to joist 310 via at least two ceiling connecting members 340, which attach to the top flange, bottom flange, or both, of joist 310. In one embodiment (not shown), ceiling connecting members 340 are attached to at least one hanger, which is, in turn, attached to joist 310. Alternatively, ceiling connecting members 340 are attached to both at least one hanger and joist 310. In one embodiment, actuation system 320 is attached to ceiling connecting members 340 via a mounting plate 345.

A control cable 350 is operatively connected to actuation system 320 and configured to activate actuation system 320 remotely, such as from a wall switch. Alternatively, control cable 350 is configured to operatively connect actuation system 320 and a computer, permitting activation of actuation system 320 via a computer interface.

Trapeze system 330 further includes a trapeze handle 355 connected to a support bar 360. Support bar 360 is connected to, and substantially perpendicular to, two or more rails 315. Support bar 360 may be connected to rails 315 via at least one bracket, which may be configured to move longitudinally along rail 315. Further, trapeze handle 355 may be connected to support bar 360 in such a manner as to allow trapeze handle 355 to move longitudinally along support bar 360.

As illustrated in FIG. 3a, rails 315, trapeze system 330, and actuation system 320 extend below the ceiling surface 365 and extend into the patient room, while the remainder of apparatus 300's components are concealed above ceiling surface 365.

In another embodiment, actuation system 320 comprises an actuator, which is at least one of a screw drive, synchronized electrical drive, a pneumatic drive, a magnetic drive, a spring, and a mechanical drive.

FIG. 3b illustrates an example actuation system 320 for use with the retractable ceiling mounted over-bed trapeze apparatus illustrated in FIG. 3a. Actuation system 320 includes a linear actuator 325. In the illustrated embodiment, linear actuator 325 is a screw drive. Actuation system 320 is secured to a joist (not shown) by ceiling connecting members 340 and mounting plate 345.

Control cable 350 is operatively connected to actuation system 320 and configured to cause the activation of actuation system 320. In activating actuation system 320, linear actuator 325 is caused to extend or retract, which in turn causes the raising and lowering of rails 315. In one embodiment, rails 315 are configured to retract above ceiling surface 365 and into the ceiling. In another embodiment, rails 315 are configured to retract to a position below ceiling surface 365, but above the typical position in which rails 315 would be utilized by a patient. In another embodiment, rails 315 are configured to be utilized when positioned between an uppermost and lowermost position, such that a user can configure the desired height for rails 315. In one embodiment, linear actuator 325 is oriented substantially vertically such that extension or retraction of linear actuator 325 causes rails 315 to move substantially vertically. In another embodiment, a series of linear actuators 325 are utilized and are synchronized so as to move rails 315 uniformly. In yet another embodiment, a series of linear actuators 325 are utilized and are independently controlled, such that rails 315 can be moved independent of one another, and/or one end of a single rail 315 can be moved independent of another end, so as to cause rail 315 to be positioned at a non-horizontal angle. In one embodiment, control cable 350 is operatively connected to a locking mechanism (not shown) configured to selectively prevent or allow movement of actuation system 320 and rails 315.

A segmented cover 370 may at least substantially encase linear actuator 325. Segmented cover 370 may comprise a series of sleeves configured to fit inside one another in a telescoping manner. In one embodiment, cover 370 performs a safety function, preventing access to linear actuator 325 by unauthorized individuals and, thus, preventing harm. In another embodiment, cover 370 performs a health function, preventing exposure of the patient or user to dirt, grease, and other contaminates contained upon or within linear actuator 325. In another embodiment, cover 370 performs an aesthetic function to conceal less attractive components of actuation system 320. In yet another embodiment, cover 370 performs a combination of two or more of the above-referenced functions. Cover 370 may be made of any material of appropriate strength, durability, and ability to be disinfected to perform its function in a care environment, including without limitation: a metal, an alloy, a polymer, a compound material, wood, and stainless steel. Additionally, a trim ring 375 may be provided to fill any void between segmented cover 370 and ceiling surface 365, for the same purposes as discussed above with regard to segmented cover 370.

An isolator 380 may be placed between actuation system 320 and mounting plate 345. Isolator 380 may be configured to at least one of: isolate movement initiated by actuation system 320, prevent noise created by movement of actuation system 320, and prevent vibration created by movement of actuation system 320.

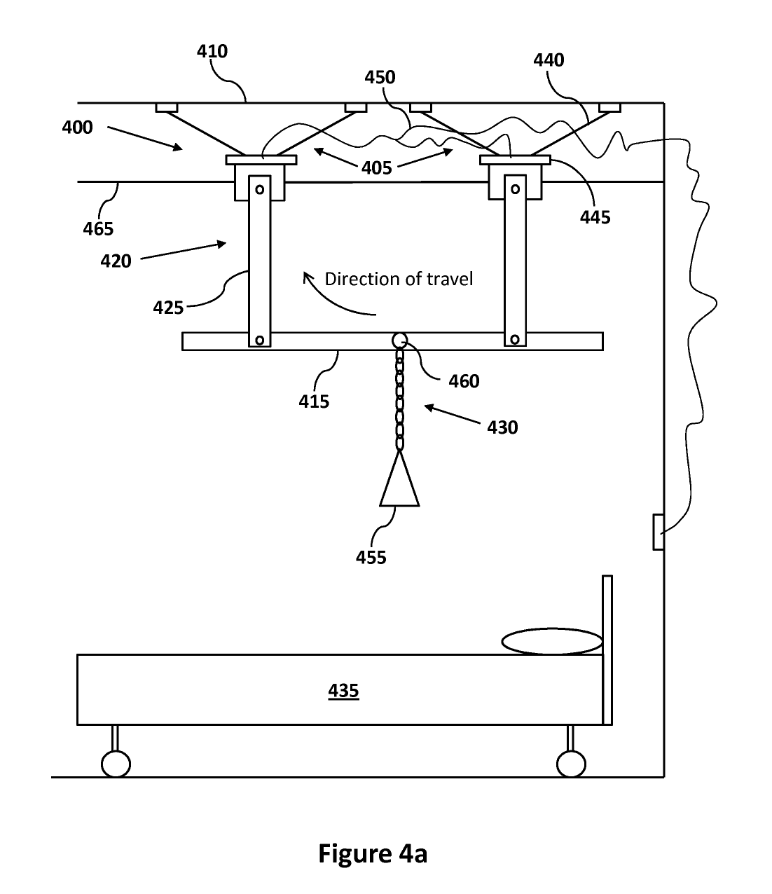

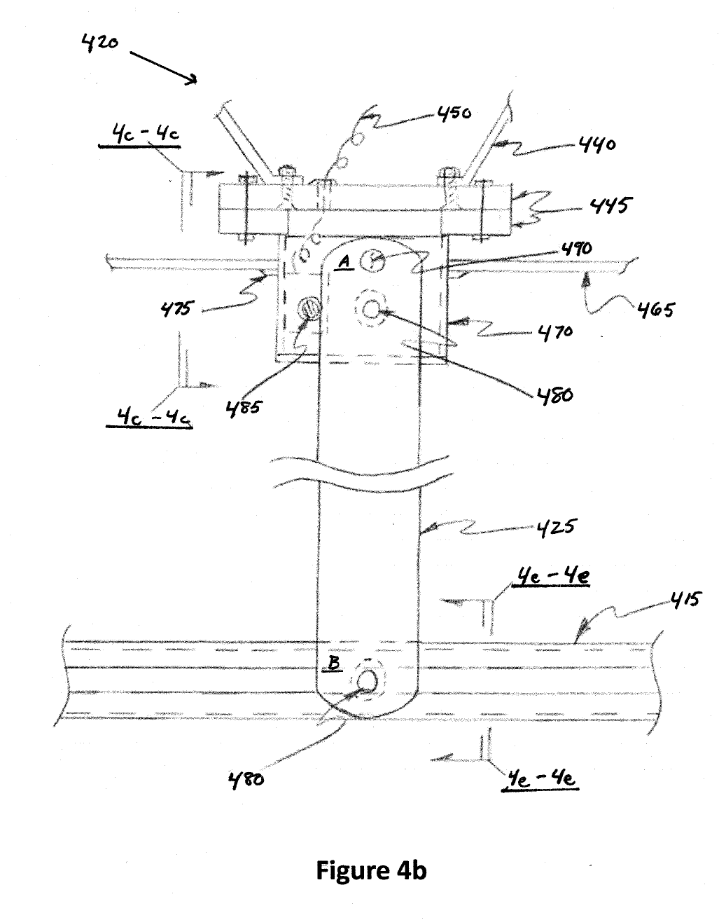

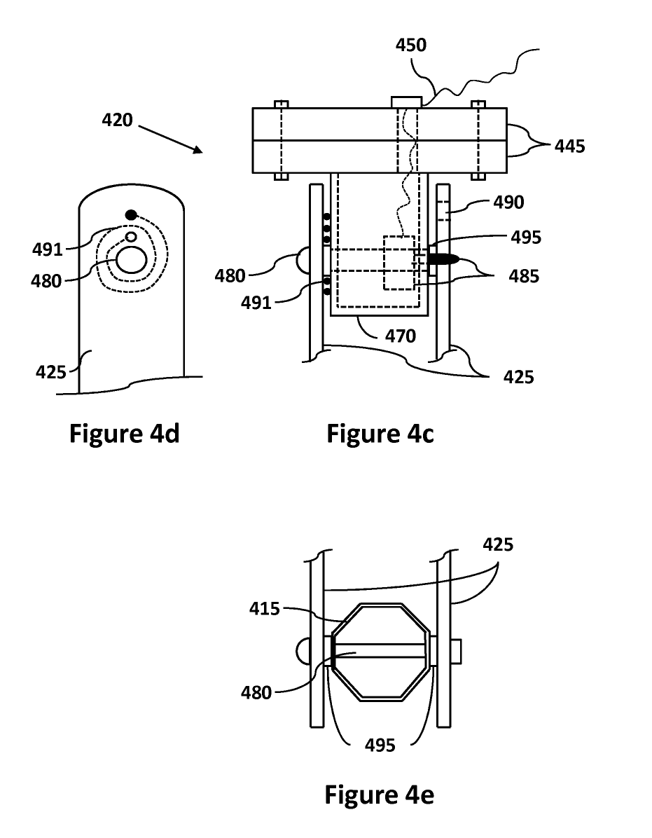

FIG. 4a illustrates an example arrangement of a retractable ceiling mounted over-bed trapeze apparatus 400. Apparatus 400 comprises a frame member 405 connected to a joist of a ceiling 410. Two or more rails 415 are spaced apart in substantially parallel arrangement, and secured to, frame member 405 via an actuation system 420. Actuation system 420 comprises a pivoting linkage 425. A trapeze system 430 is anchored to two or more rails 415 and configured to be positioned above a bed, e.g., hospital bed 435. Rails 415 are selectively positioned between an extended, lowermost position and a retracted, uppermost position, along a direction of travel as indicated in FIG. 4a.

Apparatus 400 is secured to joist 410 via at least two ceiling connecting members 440, which attach to the top flange, bottom flange, or both, of joist 410. In one embodiment (not shown), ceiling connecting members 440 are attached to at least one hanger, which is, in turn, attached to joist 410. Alternatively, ceiling connecting members 440 are attached to both at least one hanger and joist 410. In one embodiment, actuation system 420 is attached to ceiling connecting members 440 via a mounting plate 445.

In one embodiment, actuation system 420 comprises an actuator, which is at least one of a screw drive, synchronized electrical drive, a pneumatic drive, a magnetic drive, a spring, and a mechanical drive.

A control cable 450 is operatively connected to actuation system 420 and configured to activate actuation system 420 remotely, such as from a wall switch. Alternatively, control cable 450 is configured to operatively connect actuation system 420 and a computer or network, permitting activation of actuation system 420 via a computer or network interface.

Trapeze system 430 further includes a trapeze handle 455 connected to a support bar 460. Support bar 460 is connected to and substantially perpendicular to two or more rails 415. Support bar 460 may be connected to rails 415 via at least one bracket, which may be configured to move longitudinally along rail 415. Further, trapeze handle 455 may be connected to support bar 460 in such a manner as to allow trapeze handle 455 to move longitudinally along support bar 460.

As illustrated in FIG. 4a, rails 415, trapeze system 430, and actuation system 420 extend below the ceiling surface 465 and extend into the patient room, while the remainder of apparatus 400's components are concealed above ceiling surface 465.

FIG. 4b illustrates a side view of an example actuation system 420 for use with the retractable ceiling mounted over-bed trapeze apparatus illustrated in FIG. 4a. Actuation system 420 includes a pivoting linkage 425. In the illustrated embodiment, pivoting linkage 425 is configured to attach to and pivot at an axle mount 470 at a first end A, and attach to and pivot at rail 415 at a second end B. Axle mount 470 is connected to mounting plate 445 and a trim ring 475 is positioned within the void created between axle mount 470 and ceiling surface 465. Pivoting linkage 425 pivots at both first end A and second end B about pivot point pins 480. Axle mount 470 additionally includes a locking pin 485 mounted to axle mount 470 and configured to engage locking point 490 at first end A. Locking point 490 may comprise a hole, notch, groove, or other cavity within which locking pin 485 may selectively be inserted to prevent pivoting of pivoting linkage 425. Locking pin 485 may be manipulated by a locking pin actuator specifically oriented to cause locking pin 485 to selectively extend into and retract from locking point 490, and locking pin actuator may be operatively connected to control cable 450. Via control cable 450, locking pin actuator may be engaged and disengaged remotely. Alternatively, locking pin 485 may be manually manipulated by a user.

In operation, rail 415 is selectively retracted or extended via the pivoting motion of a plurality of pivoting linkages 425 (at least one of each end of rail 415), with a direction of travel indicated in FIG. 4a. For example, each pivoting linkage 425 pivots at first end A in a counter-clockwise direction about pivot pin 480, and pivots at second end B in a counter-clockwise direction about pivot pin 480. When using two or more pivoting linkages 425, the resultant motion of rail 415 is to move about an arc to the right and upward, thus retracting. When pivoting linkage 425 is oriented horizontally and rail 415 is in its rightmost position, locking point 490 is approximately aligned with locking pin 485. Locking pin 485 may be caused to engage locking point 490 such that pivoting linkage 425, and thus, rail 415 is arrested. When it is desired to extend rail 415 to its lowermost position, lock pin 485 may be disengaged from locking point 490, thus permitting pivoting linkage 425, and thus, rail 415 to rotate about an arc to the left and downward.

FIG. 4c illustrates a front view about 4c-4c in FIG. 4b. Actuation system 420 includes two pivoting linkages 425 (one on a first side of axle mount 470 and one on a second side of axle mount 470), mounting plate 445, control cable 450, axle mount 470, pivot point 480, lock pin 485, and lock point 490.

FIG. 4c additionally illustrates an example actuator 491, in this case a spring coiled about pivot point 480 and having one end fixed to axle mount 470, and another end fixed to pivoting linkage 425. Tension in the spring of actuator 491 causes pivoting linkages 425 to be biased in one rotational direction, as desired. In one embodiment, actuator 491 causes linkages 425 and, thus, rails 415 to be biased toward an upward, retracted position. In another embodiment, actuator 491 causes linkages 425 and, thus, rails 415 to be biased toward a downward, extended position.

In another embodiment, actuator 491 is at least one of a linear actuator, screw drive, synchronized electrical drive, a pneumatic drive, a magnetic drive, and a mechanical drive, capable of causing rotational movement of pivoting linkage 425 so as to selectively extend or retract rails 415. In one embodiment, rail 415 is connected to a plurality of pivoting linkages 425 (at least one of each end of rail 415), which are synchronized to move simultaneously thus causing the even extension and retraction of rail 415. In another embodiment, actuator system 420 is configured to cause rail 415 to be locked in a position between its uppermost and lowermost position. In one embodiment, rail 415 is retracted to a position above ceiling surface 465 and into the ceiling. In another embodiment, rail 415 is retracted to a position below ceiling surface 465 but above its lowermost position.

Also illustrated in FIG. 4c is at least one busing 495 placed between axle mount 470 and pivoting linkages 425 so as to reduce friction between the two.

FIG. 4d illustrates a side view of a pivoting linkage 425, including a pivot point 480 and an actuator 491.

FIG. 4e illustrates a front view about 4e-4e in FIG. 4b. Rail 415 includes a plurality of pivoting linkages 425 (one to a first side of rail 415, and one to a second side or rail 425), fixed about pivot point 480. Bushings 495 are placed between rail 415 and pivoting linkages 425 so as to reduce friction between the two.

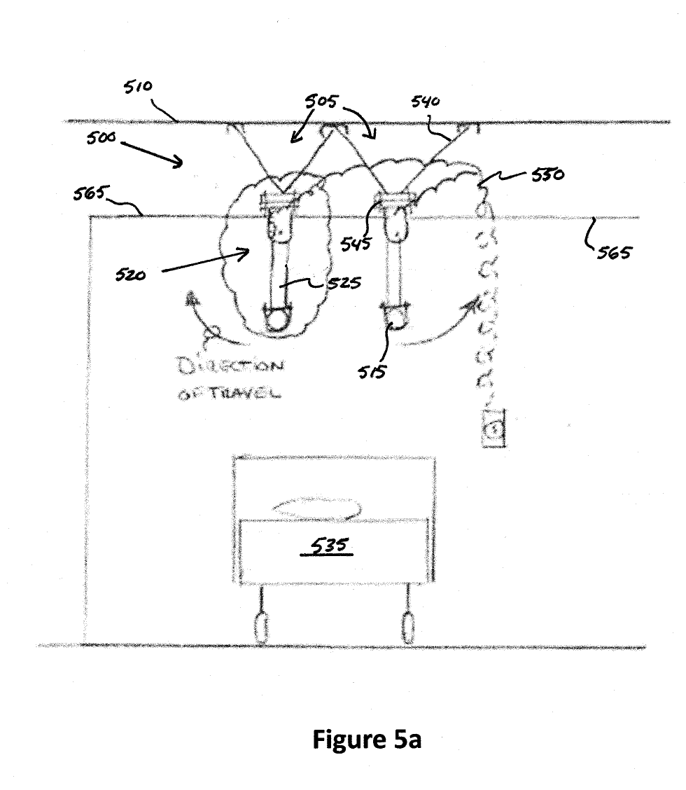

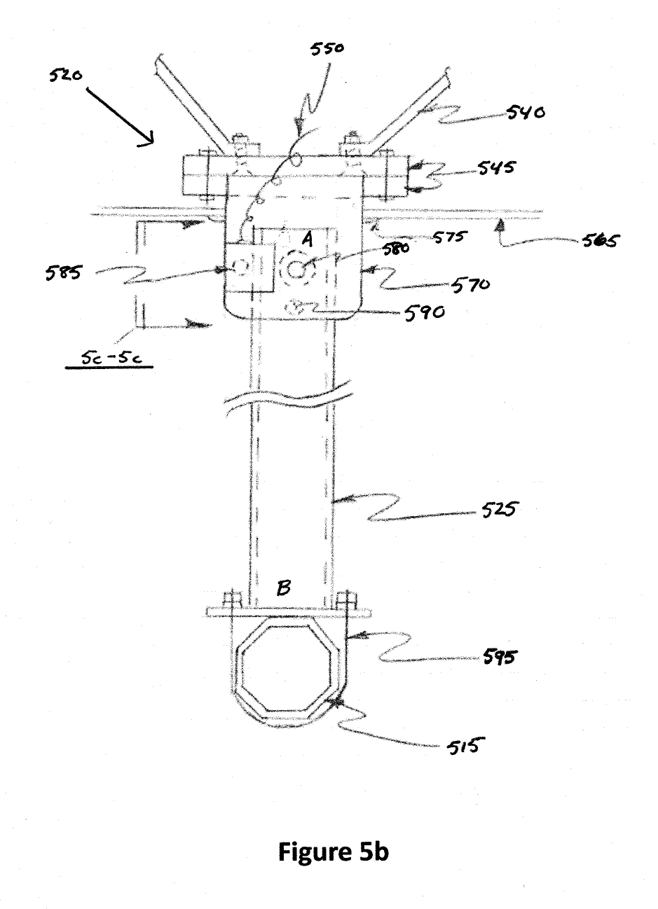

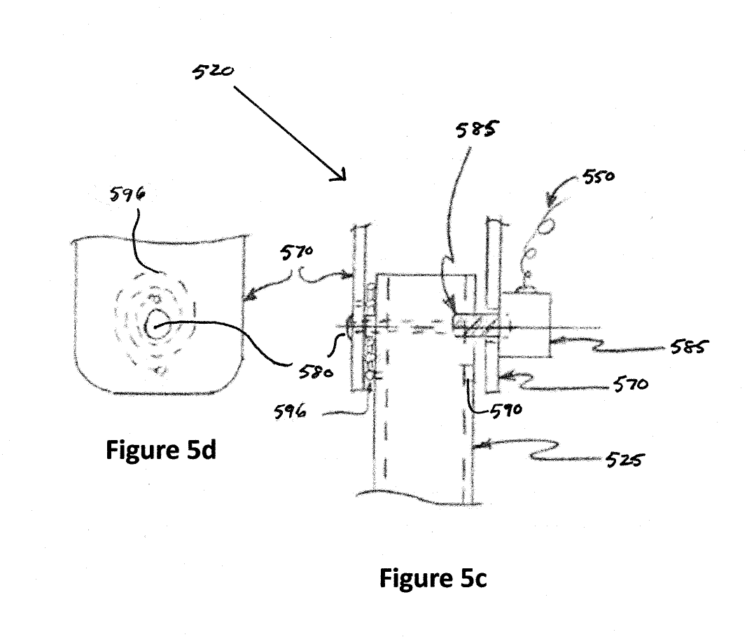

FIG. 5a illustrates an example arrangement of a retractable ceiling mounted over-bed trapeze apparatus 500. Apparatus 500 comprises a frame member 505 connected to a joist of a ceiling 510. Two or more rails 515 are spaced apart in substantially parallel arrangement, and secured to, frame member 505 via an actuation system 520. Actuation system 520 comprises a pivoting linkage 525. Two or more rails 515 and configured to be positioned above a bed, e.g., hospital bed 535. Rails 515 are selectively positioned between an extended, lowermost position and a retracted, uppermost position, along a direction of travel as indicated in FIG. 5a.

Apparatus 500 is secured to joist 510 via at least two ceiling connecting members 540, which attach to the top flange, bottom flange, or both, of joist 510. In one embodiment (not shown), ceiling connecting members 540 are attached to at least one hanger, which is in turn attached to joist 510. Alternatively, ceiling connecting members 540 are attached to both at least one hanger and joist 510. In one embodiment, actuation system 520 is attached to ceiling connecting members 540 via a mounting plate 545.

In one embodiment, actuation system 520 comprises an actuator, which is at least one of a screw drive, synchronized electrical drive, a pneumatic drive, a magnetic drive, a spring, and a mechanical drive.

A control cable 550 is operatively connected to actuation system 520 and configured to activate actuation system 520 remotely, such as from a wall switch. Alternatively, control cable 550 is configured to operatively connect actuation system 520 and a computer, permitting activation of actuation system 520 via a computer interface.

As illustrated in FIG. 5a, rails 515 and actuation system 520 extend below the ceiling surface 565 and extend into the patient room, while the remainder of apparatus 500's components are concealed above ceiling surface 565.

FIG. 5b illustrates a side view of an example actuation system 520 for use with the retractable ceiling mounted over-bed trapeze apparatus illustrated in FIG. 5a. Actuation system 520 includes a pivoting linkage 525. In the illustrated embodiment, pivoting linkage 525 is configured to attach to and pivot at an axle mount 570 at a first end A, and attach to rail 515 at a second end B. Axle mount 570 is connected to mounting plate 545 and a trim ring 575 is positioned within the void created between axle mount 570 and ceiling surface 565. Pivoting linkage 525 pivots at first end A about pivot point pin 580. Axle mount 570 additionally includes a locking pin 585 mounted to axle mount 570 and configured to engage locking point 590 at first end A. Locking point 590 may comprise a hole, notch, groove, or other cavity within which locking pin 585 may selectively be inserted to prevent pivoting of pivoting linkage 525. Locking pin 585 may be manipulated by a locking pin actuator specifically oriented to cause locking pin 585 to selectively extend into and retract from locking point 590, and locking pin actuator may be operatively connected to control cable 550. Via control cable 550, locking pin actuator may be engaged and disengaged remotely. Alternatively, locking pin 585 may be manually manipulated by a user.

In operation, rail 515 is selectively retracted or extended via the pivoting motion of a pivoting linkage 525, with a direction of travel indicated in FIG. 5a. Pivoting linkage 525 is attached to rail 515 via a rail connecting member 595. For example, pivoting linkage 525 pivots at first end A in a clockwise direction about pivot pin 580. The resultant motion of rail 515 is to move about an arc to the left and upward, thus retracting. When pivoting linkage 525 is oriented horizontally and rail 515 is in its leftmost position, locking point 590 is approximately aligned with locking pin 585. Locking pin 585 may be caused to engage locking point 590 such that pivoting linkage 525, and thus, rail 515 is arrested. When it is desired to extend rail 515 to its lowermost position, lock pin 585 may be disengaged from locking point 590, thus permitting pivoting linkage 525, and thus, rail 515 to rotate about an arc to the left and downward.

FIG. 5c illustrates a front view about 5c-5c in FIG. 5b. Actuation system 520 includes pivoting linkage 525, control cable 550, axle mount 570, pivot point pin 580, lock pin 585, and lock point 590.

FIG. 5c additionally illustrates an example actuator 596, in this case, a spring coiled about pivot point 580 and having one end fixed to axle mount 570, and another end fixed to pivoting linkage 525. Tension in the spring of actuator 596 causes pivoting linkage 525 to be biased in one rotational direction, as desired. In one embodiment, actuator 596 causes linkage 525, and thus rail 515 to be biased toward an upward, retracted position. In another embodiment, actuator 596 causes linkage 525, and thus rail 515 to be biased toward a downward, extended position.

In another embodiment, actuator 596 is at least one of a linear actuator, screw drive, synchronized electrical drive, a pneumatic drive, a magnetic drive, and a mechanical drive, capable of causing rotational movement of pivoting linkage 525 so as to selectively extend or retract rail 515. In one embodiment, rail 515 is connected to a plurality of pivoting linkages 525 (at least one of each end of rail 515), which are synchronized to move simultaneously thus causing the even extension and retraction of rail 515. In another embodiment, actuator system 520 is configured to cause rail 515 to be locked in a position between its uppermost and lowermost position. In one embodiment, rail 515 is retracted to a position above ceiling surface 565 and into the ceiling. In another embodiment, rail 515 is retracted to a position below ceiling surface 565 but above its lowermost position.

FIG. 5d illustrates a side view of axle mount 570, including a pivot point 580 and an actuator 596.

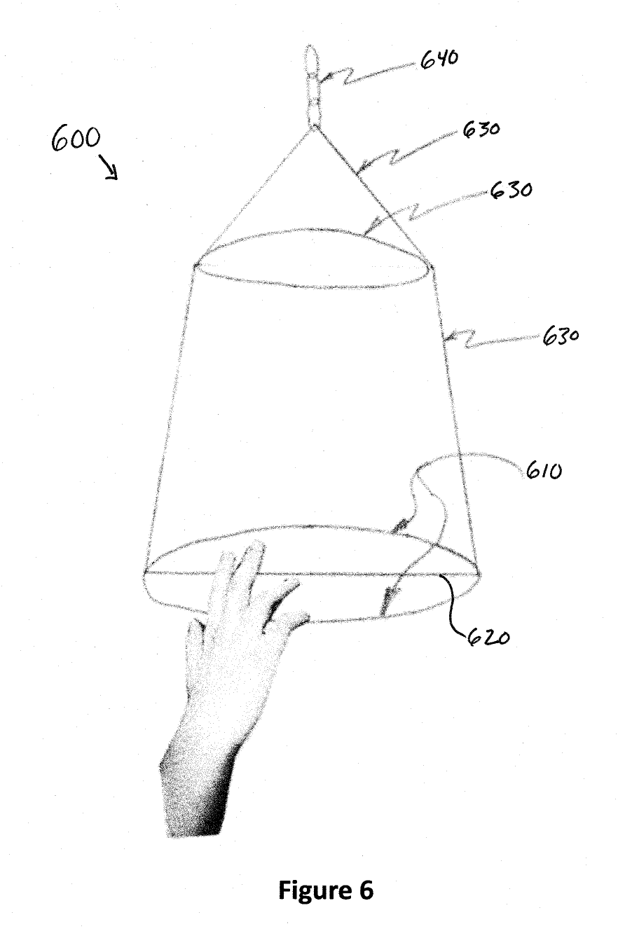

FIG. 6 illustrates an example trapeze handle 600, including a first grasping member 610, a second grasping member 620, a supporting structure 630, and an adjustable connection device 640. In practice, trapeze handle 600 is configured to allow a user to grasp it regardless of its orientation with respect to the user.

First grasping member 610 may include a substantially horizontal handle having a horizontal cross-section that is at least one of substantially circular and substantially oval. The handle surface may have at least one of a substantially circular profile, flat profile, or rectilinear profile, and may be made from bar stock, flat stock square stock, round tubing, and square tubing materials. In one embodiment, first grasping member 610 is configured to be grasped by a user anywhere about its surface. In another embodiment, first grasping member 610 is coated with a soft cover. In another embodiment, first grasping member 610 is configured to be grasped by a user at designated portions, which portions may comprise discontinuous soft covers. In one embodiment, first grasping member 610 is approximately 14 inches in diameter. In another embodiment, first grasping member 610 is approximately 8 inches to 20 inches in diameter.

Second grasping member 620 may include a substantially horizontal handle having a horizontal cross-section that is substantially linear. The handle surface may have at least one of a substantially circular profile, flat profile, or rectilinear profile, and may be made from bar stock, flat stock square stock, round tubing, and square tubing materials. In one embodiment, second grasping member 620 is configured to be grasped by a user anywhere about its surface. In another embodiment, second grasping member 620 is coated with a soft cover. In another embodiment, second grasping member 620 is configured to be grasped by a user at designated portions, which portions may comprise discontinuous soft covers. In one embodiment, second grasping member 620 is connected to first grasping member 610. In another embodiment, second grasping member 620 is connected to first grasping member 610 in at least one point, and extends at least partially across first grasping member 610. In another embodiment, second grasping member 620 is connected to first grasping member 610 at two points, the first point being substantially opposite the second point, such that second grasping member 620 extends completely across first grasping member 610, as is illustrated in FIG. 6. First grasping member 610 and second grasping member 620 may be connected using a variety of fasteners, as have been discussed previously in this application. In another embodiment, first grasping member 610 and second grasping member 620 are integrally connected. In another embodiment, first grasping member 610 and second grasping member 620 are welded together. In another embodiment, second grasping member 620 extends through holes in first grasping member 610. In one embodiment, second grasping member 620 is approximately 14 inches in length. In another embodiment, second grasping member 620 is approximately 8 inches to 20 inches in length.

The soft cover may be a continuous cover, extending along the entirety of the horizontal handle portion of first grasping member 610 and/or second grasping member 620, or alternatively may include a series of discontinuous covers oriented along the horizontal handle portion of first grasping member 610 and/or second grasping member 620. The soft cover may be configured to be removed from first grasping member 610 and/or second grasping member 620, or may be adhered to first grasping member 610 and/or second grasping member 620. In an embodiment wherein the soft cover is removable, the soft cover may be made of a material that is easily cleanable, such as a cloth material. In an alternative embodiment, the soft cover is made of a rubber material that is easily cleanable whether removable or adhered to first grasping member 610 and/or second grasping member 620. The soft cover may be made out of a variety of materials sufficient to create a surface capable of being comfortably gripped and/or allowing a user to achieve substantial purchase on the handle.

Supporting structure 630 is configured to operatively connect first grasping member 610 and/or second grasping member 620 to a rail (not shown). Supporting structure 630 may include at least one substantially vertical member extending above first grasping member 610 and second grasping member 620, such that first grasping member 610 and second grasping member 620 are connected to a proximate end of supporting structure 630, and adjustable connection device 640 is connected to a distal end of supporting structure 630. In one embodiment, as illustrated in FIG. 6, supporting structure 630 comprises a series of members comprising a frame, which is in turn connected to adjustable connection device 640. In another embodiment, supporting structure 630 is configured to be easily cleaned.

Adjustable connection device 640 operatively attaches supporting structure 630, and thus first grasping member 610 and second grasping member 620, to a rail (not shown). Adjustable connection device 640 is configured to support first grasping member 610 and second grasping member 620 in at least two height positions. In one embodiment, adjustable connection device 640 supports first grasping member 610 and second grasping member 620 in various height positions. In another embodiment, adjustable connection device 640 supports first grasping member 610 and second grasping member 620 in an infinite number of height positions. Adjustable connection device 640 may be at least one of a chain, rope, cable, rod, screw, or other substantially vertical member capable of selectively lengthening or shortening. In one embodiment, adjustable connection device 640 is comprised of any flexible material resistant to substantial elongation and capable of supporting the weight of a human user. In one embodiment, adjustable connection device 640 is a chain, which is connected to supporting structure 630 and/or rail (not shown) by a hook, such that a user can easily hook the chain in a desired link so as to effect height adjustment. In another embodiment, adjustable connection device 640 is configured to be easily cleaned.

Each of first grasping member 610, second grasping member 620, supporting structure 630 and adjustable connection device 640 may be constructed of a variety of materials, including without limitation: a metal, a polymer, an alloy, compound materials, and wood. In one embodiment, one or more of these elements may comprise materials having hollow interiors configured to at least one of reduce the weight of the material and permit control and power wires to be run therein. In another embodiment, one or more of these elements may be constructed of one or more materials that is easily cleaned and disinfected, such as stainless steel, as would be preferable in a healthcare setting. In another embodiment, each of these elements is made of a material having sufficient strength and durability to support the weight of a human user.

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

As stated above, while the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, illustrative examples shown, or any apparatus referred to. For example, the examples and figures disclosed herein generally refer to and depict a hospital environment. However, the present application and the appurtenant claims are equally applicable to any type of care environment (e.g., a nursing home or other long term care facility, or one's own private residence). Departures may be made from such details, examples, and apparatuses without departing from the spirit or scope of the general inventive concept.

What is claimed is:

1. An apparatus, comprising:
a frame member attached to a joist of a ceiling;
two or more rails spaced apart in a substantially parallel arrangement and secured to and below the frame member; and
a trapeze system anchored to the two or more rails and configured to be positioned above a bed.

2. The apparatus of claim 1, wherein the frame member comprises at least two ceiling connecting members each having an upper end secured to the joist of a ceiling and a lower end which extends to, slightly below, or slightly above the ceiling surface.

3. The apparatus of claim 2, wherein the frame member further comprises at least two rail connecting members each having an upper end secured to the lower end of a ceiling connecting member and being configured to receive the two or more rails.

4. The apparatus of claim 3, wherein the frame further comprises a mounting plate positioned between each ceiling connecting member and each rail connecting member, wherein the plate connects the upper end of each rail connecting member to the lower end of a ceiling connecting member.

5. The apparatus of claim 2, wherein the lower end of each of the ceiling connecting members comprises a mounting plate configured to receive and secure the rails.

6. The apparatus of claim 1, wherein the trapeze system further comprises a bracket having a top opening configured to receive one of the rails and a bottom opening configured to receive a support bar positioned approximately perpendicular to the two or more rails.

7. The apparatus of claim 6, wherein the trapeze system further comprises a trapeze handle connected to the support bar.

8. The apparatus of claim 1, wherein the trapeze system further comprises a trapeze handle, comprising:
a first grasping member comprising a substantially horizontal handle having a horizontal cross-section that is at least one of substantially circular and substantially oval;
a second grasping member connected to the first grasping member in at least one point and extending at least partially across the first grasping member, the second grasping member comprising a substantially horizontal handle having a horizontal cross-section that is substantially linear;
a supporting structure operatively connecting first and second grasping members to the two or more rails; and
an adjustable connection device configured to operatively connect the supporting structure to the two or more rails, wherein the adjustable connection device causes the first and second grasping member to remain in at least two height positions.

9. An apparatus, comprising:
a frame member attached to a joist of a ceiling;
two or more rails spaced apart in substantially parallel arrangement and secured to the frame member;
a trapeze system anchored to the two or more rails and configured to be positioned above a bed;
wherein the frame member comprises at least two ceiling connecting members each having an upper end secured to the joist of a ceiling, and a lower end, which extends to, slightly below, or slightly above the ceiling surface,
wherein the ceiling connecting members are arranged in a linear, square, or rectangular configuration, and
at least two rail connecting members each having an upper end secured to the lower end of a ceiling connecting member and configured for receiving the two or more rails.

10. The apparatus of claim 9, wherein the frame further comprises a mounting plate positioned between each ceiling connecting member and each rail connecting member, wherein the plate connects the upper end of each rail connecting member to the lower end of a ceiling connecting member.

11. The apparatus of claim 9, wherein the lower end of each of the ceiling connecting members comprises a mounting plate configured to receive and secure the rails.

12. The apparatus of claim 9, wherein the trapeze system further comprises a bracket having a top opening configured to receive one of the rails and a bottom opening configured to receive a support bar positioned approximately perpendicular to the two or more rails.

13. The apparatus of claim 12, wherein the trapeze system further comprises a trapeze handle connected to the support bar.

14. An apparatus, comprising:
a frame member attached to a joist of a ceiling;
two or more rails spaced apart in substantially parallel arrangement and secured to and under the frame member;
an actuation system comprising at least one of a linear actuator and a pivoting linkage, operatively connected to the frame member and two or more rails, wherein the actuation system is configured to cause at least one of the raising and lowering of the two or more rails; and
a trapeze system anchored to the two or more rails and configured to be positioned above a bed.

15. The apparatus of claim 14, wherein the actuation system comprises at least one of a screw drive, synchronized electrical drive, a pneumatic drive, a magnetic drive, a spring, and a mechanical drive.

16. The apparatus of claim 14, further comprising a locking mechanism operatively connected to the actuation system and configured to selectively restrict movement of the two or more rails.

17. The apparatus of claim 14, wherein the frame further comprises at least two ceiling connecting members.

18. The apparatus of claim 17, further comprising a mounting plate positioned between each ceiling connecting member and the actuation system, wherein the plate connects the upper end of the actuation system to the lower end of at least one ceiling connecting member.

19. The apparatus of claim 14, further comprising a control cable operatively connected to the actuation system and configured to selectively engage at least one of the linear actuator and the pivoting linkage to cause at least one of raising and lowering of the two or more rails.

20. The apparatus of claim 14, wherein the trapeze system further comprises a trapeze handle connected to a support bar, wherein the support bar is connected to and substantially perpendicular to the two or more rails.
